(19) United States
(12) Patent Application Publication
(10) Pub. No.: US 2008/0150897 A1
(43) Pub. Date: Jun. 26, 2008

(54) Optical structure for a laser input device

(76) Inventor: Timothy Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/643,853

(22) Filed: Dec. 22, 2006

(51) Int. Cl. G06F 3/033

(52) U.S. Cl. 345/166

(57) ABSTRACT

An optical structure of a laser input device includes an input device body; a laser source, inside the input device body to emit a laser light beam which travels linearly along a determined incident path to a work surface; a splitter, having a first interface and a second interface behind the first interface, wherein the first interface and the second interface are in a light reflecting path of the laser light beam and reflect respective axial light beams which have the same frequency and intersect with each other; and a light sensor, located at an intersection of the axial light beams for sensing a light interference strip pattern formed by intersecting the axial light beams. Moving direction and displacement of the input device on a work surface can be determined more precisely by sensing the change of the light interference strip pattern.

### BACKGROUND OF THE INVENTION

1. Field of the Invention

The invention generally relates to an optical structure of a laser input device. More particularly, the invention relates to an optical structure with a splitter, which splits a light beam into two sub-beams, which have the same frequency and intersect with each other. A light interference strip pattern is formed at the intersection of the two sub-beams. By sensing the change of the light interference strip pattern, data of moving direction and displacement of the input device on a work surface is read to precisely determine the moving direction and displacement of the input device.

2. Description of the Related Art

As the development of technology progresses, personal computer has been playing an important role in our daily life. An input device is essential to the personal computer as a peripheral. The input device such as a mouse and a keyboard has been developing to a new profile in order to catch up with the updating functions of computers. The mouse has more and more functions than just text input, particularly in the use of multi-media and Internet, due to its superior freedom and controllability.

The currently commercial available mouse has main types of structural configuration: mechanically driven mouse and optical mouse. The mechanically driven mouse has a track ball on its bottom. The track ball rotates as the mechanically driven mouse moves. The rotation of the track ball drives the sensor mounted inside the mouse to measure the mouse's moving distance. Despite of the advantages of mechanically driven mouse such as low technical level and low manufacture cost, the mechanically driven mouse still suffers from wear of the track ball used over a period of time and accumulation of dust and spots inside the mouse, which might adversely affect normal operation of the mouse and operational control precision of the mouse gradually lowers as time elapses.

The optical mouse uses a light source, usually a red light source, to emit light onto a subjective surface and takes reflected light in certain time period. By comparing the amount of reflected light beams in determined time period with scanning times per second, moving direction and displacement can be calculated.

The optical mousse eliminates the disadvantages of track ball wear and dust accumulation encountered by the mechanically driven mouse. However, the optical mouse has more complicate structure and thus has higher manufacture cost than the mechanically driven mouse. The operational control precision of the optical mouse depends on pixel size of a light sensor and whether the light sensor can properly take light beams reflected by the objective surface. In other words, the more properly the reflected light beams being taken, the higher the control precision of the optical mouse gets.

Conventional optical mouse, such as TW Patent no. 245 538, title of optical mouse structure, includes a light source (light-guiding projector), which is used to emit light beams, and a light sensor (image sensing element).

The light sensor faces downward the objective surface and locates in a light reflecting path of the light beams. When the light beams are reflected by the objective surface along the light reflecting path to pass through the light sensor, the light sensor takes them for image analysis. While the light source (light-guiding projector) emits light onto the objective surface and generates lights and shadows with subtle gradations, the sensor (image sensing element) continuously takes images and senses difference of light spots on the objective surface due to the movement of the mouse.

Then, a backend signal processing element accordingly calculates the moving direction and displacement of the optical mouse.

Therefore, it is found that whether the optical mouse precisely calculates the moving direction and displacement closely depends on the emission of the light source and good recognition of lights ad shadows with subtle gradation.

In the conventional structure as set forth above, the light beams seriously scatter after they are reflected by the objective surface. Furthermore, the light sensor has light loss problem in receiving the reflected light beams from the objective surface, which leads to insufficient data for image analysis and therefore could not precisely calculate moving direction and displacement for the mouse. As a result, a cursor on a screen of a computer monitor runs up and down or dislocates, which cannot allow the operational sensitivity of the optical mouse improved and thus disadvantageously lowers the convenience in use.

Therefore, there is a need of an improved optical structure of a laser input device, which has cured the insufficiency encountered in the prior art.

### SUMMARY OF THE INVENTION

One of objects of the invention is to provide an optical structure of a laser input device, which uses a beam-aggregating laser as its light source. Laser light beam is split into two reflected light beams, with the same frequencies, which then intersect with each other to form a light interference strip pattern at intersection. Moving direction and displacement of the input device on a work surface can be determined more precisely by sensing the change of the light interference strip pattern.

An optical structure of a laser input device includes an input device body; a laser source, inside the input device body to emit a laser light beam which travels linearly along a determined incident path to a work surface; a splitter, having a first interface and a second interface behind the first interface, wherein the first interface and the second interface are in a light reflecting path of the laser light beam and reflect respective axial light beams which have the same frequency and intersect with each other; and a light sensor, located at an intersection of the axial light beams for sensing a light interference strip pattern formed by intersecting the axial light beams.

To provide a further understanding of the invention, the following detailed description illustrates embodiments and examples of the invention, this detailed description being provided only for illustration of the invention.

In the structure as above, when the input device body moves, the direction and displacement can be determined by sensing the change of the light interference strip patterns.

### BRIEF DESCRIPTION OF THE DRAWINGS

FIG. 1 is a cross section view of an input device according to the invention;

FIG. 2 is a perspective view of a lens base and a splitter of an input device according to the invention;

FIG. 3 is a schematic view showing the assembling of a light source and a light sensor of an input device according to the invention;

FIG. 4 is a cross section view of a part of an input device according to the invention;

FIG. 5 is a schematic view showing the traveling of light inside an input device in operation according to the invention.

FIG. 6 is a schematic view showing the light interference phenomenon.

### DETAILED DESCRIPTION OF THE EMBODIMENTS

Wherever possible in the following description, like reference numerals will refer to like elements and parts unless otherwise illustrated.

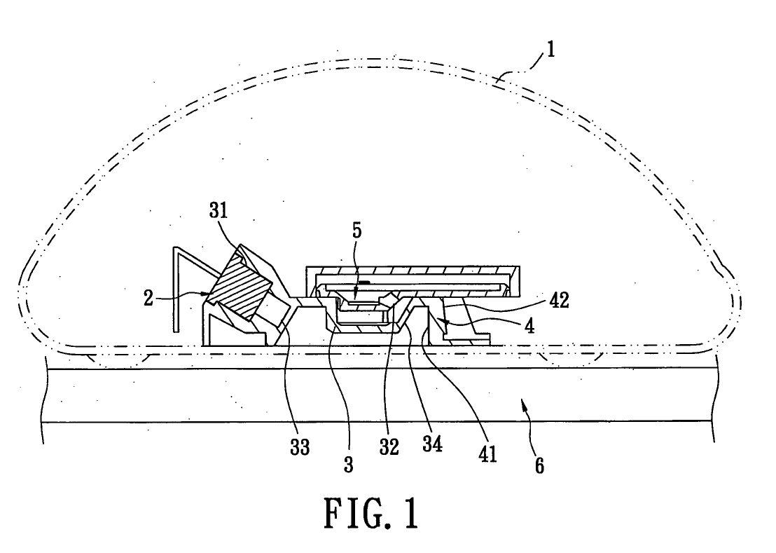

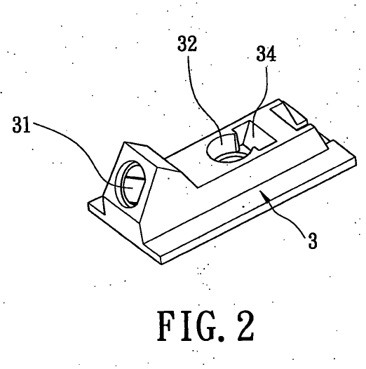

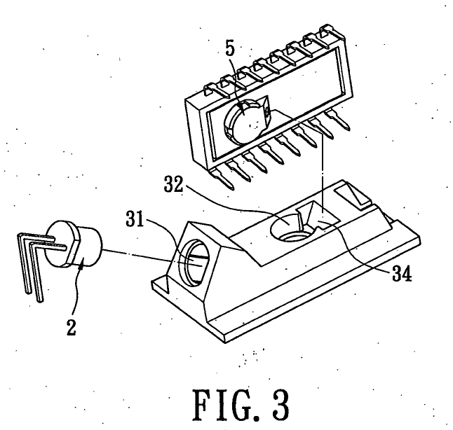

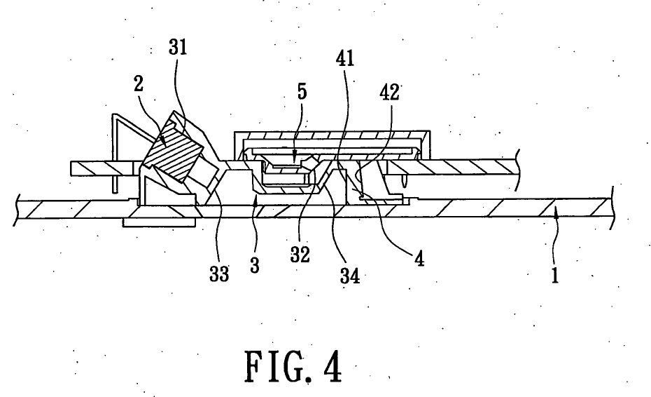

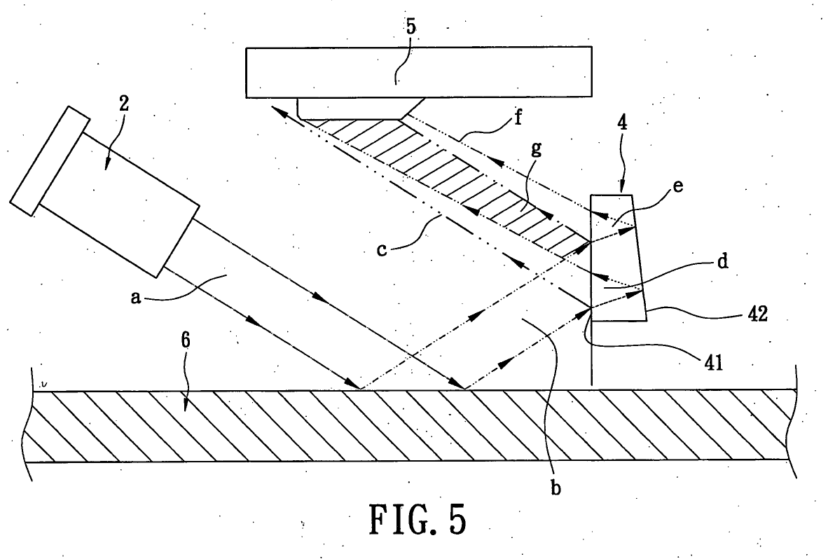

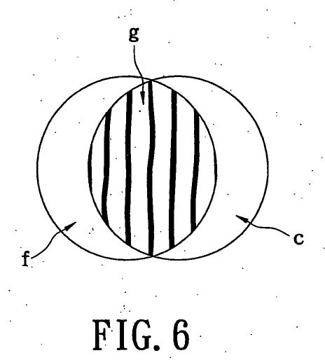

As shown in FIG. 1, FIG. 2, FIG. 3, FIG. 4, FIG. 5 and FIG. 6, the input device of the invention includes an input device body 1, a laser source 2, a lens base 3, a splitter 4 and a light sensor 5. The laser source 2 is mounted inside the input device body 1 to provide a laser light beam a traveling linearly to a work surface 6 at an incident angle of about 25-45 degree with respect to the work surface 6.

The splitter 4 is mounted inside the lens base 3 and in the path that the laser beam is reflected. The splitter 4 is in the form of a transparent arrow-headed mirror, having a first interface 41 and a second interface 42 behind the first interface 4 at an angle of 0.1-10 degree between the first interface 41 and the second interface 42. A part of the light beam b reflected by the work surface 6 reaches the first interface 41 and reflects as a first reflected axial light beam c. Another part of the light beam passes through the first interface 41 and is refracted as a first refracted axial light beam d to reach the second interface 42. The first refracted axial light beam d is reflected by the second interface 42 to form a second reflected axial light beam e. The second reflected axial light beam e passes through the first interface 41 and is refracted as a second refracted axial light beam f. The second refracted axial light beam f intersects with the first reflected axial light beam c and a light interference strip pattern g is formed at the intersection. The first reflected axial light beam c has the same frequency as the second refracted axial light beam f.

The lens base 3 is mounted inside the input device body 1. The lens base 3 is in the path where the laser light beam is an incident and reflected. The lens base 3 has a fixing opening 31 at one side thereof for receiving the laser source 2. The lens base 3 further at its top has a recess 32 corresponding to the light sensor 5. At a bottom of the fixing opening 31 of the lens base 3 is mounted a first lens 33 which is in the incident path of the laser light beam for the laser light beam to pass through. Inside the lens base 3, a second lens 34 locates between the splitter 4 and the light sensor 5 for the first reflected axial light beam c which is reflected by the first interface 41 and the second refracted axial light beam f which is refracted by the second interface 42 to pass through.

The light sensor 5 corresponds to the recess 32 and locates at the intersection of the first reflected axial light beam c and the second refracted axial light beam f to sense the light interference strip pattern g formed by intersecting the first reflected axial light beam c with the second refracted axial light beam f.

As shown in FIG. 1, FIG. 4, FIG. 5 and FIG. 6, by the use of the fixing opening 31 at one side of the lens base 3 to receive the laser source 2 and the use of the recess 32 on the top of the lens base 3 to receive the light sensor 5, the light source 2 and the light sensor 5 are fixed in place. When in operation, the laser light beam a emitted linearly by the laser source 2 travels along the incident path at an incident angle of 25-45 degree and reaches the work surface 6 through the first lens 33 of the lens base 3. The laser light beam a reaches the work surface 6 and then is reflected as the reflected light beam b to the first interface 41 of the splitter 4 in its reflecting path. A part of the reflected light beam b is reflected by the first interface 41 to form the first reflected axial light beam c. Another part of the reflected light beam b passes through the first interface 41 and is refracted as the first refracted axial light beam d, which then reaches the second interface 42. The first refracted axial light beam d is reflected by the second interface 42 to form the second reflected axial light beam e which then reaches the first interface 41. The second reflected axial light beam e passes through the first interface 41 and is refracted as the second refracted axial light beam f After the second refracted axial light beam f intersects with the first reflected axial light beam c, the second refracted axial light beam f and the first reflected axial light beam c respectively pass through the second lens 34 of the lens base 3. Since the first reflected axial light beam c and the second refracted axial light beam f have the same frequency, the light interference strip pattern g is formed at the intersection of the first reflected axial light beam c and the second refracted axial light beam f, and is read by the light sensor 5. When the input device body 1 moves on the work surface 6, the light sensor 5 scans and takes images of the interference strip patterns therefore formed at frequency of several times per second to determine the moving direction and displacement of the input device body 1 on the work surface 6. Accordingly, moving direction and distance of a cursor on a computer screen can be calculated. The measurement sensitivity can be adjusted by changing the angle between the first interface 41 and the second interface 42 in the range of 0.1-10.

In light of the foregoing description, the input device of the invention provides advantages as follows:
1. The moving direction and displacement of the input device is determined by reading the light interference strip patterns.

Therefore the prior disadvantages such as low operational sensitivity caused by seriously scattering of single reflected light beam due to roughness of the work surface 6 can be eliminated.
2. A conventional optical mouse has complicate optical configuration, which is produced at low yield. The input device of the invention uses the splitter to split the light beam into two axial light beams, and determines the moving direction and displacement by sensing the change of interference strip patterns formed at the intersection of the two axial light beams.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An optical structure for a laser input device comprising:
an input device body;
a laser source, arranged inside the input device body for emitting a laser light beam which travels linearly along a determined light incident path to a work surface;
a splitter, having a first interface and a second interface behind the first interface, wherein the first interface and the second interface are respectivelly in a light reflecting path of the laser light beam and reflect respectivelly an axial light beam which have the same frequency and intersect with each other; and
a light sensor, located at an intersection of the axial light beams for sensing a light interference strip pattern formed by intersecting the axial light beams.

2. The optical structure for the laser input device of claim 1, wherein the laser light beam reaches the work surface at an incident angle of 25-45 degree.

3. The optical structure for the laser input device of claim 1, wherein the splitter is in the form of a transparent arrow-headed mirror, with an angle of 0.1-10 degree between the first interface and the second interface.

4. The optical structure for the laser input device of claim 1, wherein the input device body has a lens base located in the light incident path and in light reflecting path of the laser light beam.

5. The optical structure for the laser input device of claim 4, wherein the lens base has a first lens in the light incident path of the laser light beam for the laser light beam to pass through.

6. The optical structure for the laser input device of claim 4, wherein the splitter locates inside the lens base and in the light reflecting path of the laser light beam.

7. The optical structure for the laser input device of claim 4, wherein the lens base has a second lens between the splitter and the light sensor for the axial light beams reflected by the first interface and the second interface to pass through.

8. The optical structure for the laser input device of claim 4, wherein the lens base has a fixing opening for receiving the laser source.

9. The optical structure for the laser input device of claim 4, wherein the lens base has a recess for receiving the corresponding light sensor.
